(19) United States
(12) Patent Application Publication
(10) Pub. No.: US 2013/0139176 A1
(43) Pub. Date: May 30, 2013

(54) SCHEDULING FOR REAL-TIME AND QUALITY OF SERVICE SUPPORT ON MULTICORE SYSTEMS

(71) Applicant: Jaeyeon KANG, Cupertino, CA (US)

(72) Inventor: Jaeyeon KANG, Cupertino, CA (US)

(73) Assignee: SAMSUNG ELECTRONICS CO., LTD., Suwon City (KR)

(21) Appl. No.: 13/410,219

(22) Filed: Mar. 1, 2012

Related U.S. Application Data
(60) Provisional application No. 61/564,073, filed on Nov. 28, 2011.

(51) Int. Cl. G06F 9/46

(52) U.S. Cl. 718/105

(57) ABSTRACT

In a first embodiment of the present invention, a method of assigning tasks in a multicore electronic device is provided, the method comprising: receiving a set of tasks; ordering the tasks in non-increasing order of a utilization value of each task; partitioning the ordered tasks using a schedulability-centric algorithm; repartitioning the partitioned ordered tasks by reordering the partitioned ordered tasks in non-decreasing order of the utilization value of each task and partitioning the partitioned reordered tasks using a load-balancing-centric algorithm; and assigning the repartitioned tasks to one or more cores of the multicore electronic device based on results of the repartitioning.

### CROSS REFERENCE TO RELATED APPLICATIONS

This application claims the benefit of priority under 35 U.S.C. §119(e) to U.S. Provisional Patent Application No. 61/564,073, filed on Nov. 28, 2011, which is incorporated herein by reference in its entirety for all purposes.

### BACKGROUND OF THE INVENTION

1. Field of the Invention

The present invention relates generally to real-time computing systems. More specifically, the present invention relates to scheduling aspects related to real-time and quality of service support on multicore systems.

2. Description of the Related Art

Real-time computing is the study of hardware and software systems that are subject to a “real-time constraint”—e.g. operational deadlines from event to system response. Real-time programs must guarantee response within hard or soft time constraints. Often real-time response times are understood to be in the order of milliseconds and sometimes microseconds. In contrast, a non-real-time system is one that does not need to guarantee a response time in any situation, even if a fast response is the usual result. Real-time computer systems have been recently found in many diverse areas, including, for example, automotive electronics, avionics, space systems, control centers, communications systems, video conferencing, medical imaging, and computer electronics.

Furthermore, as multicore processors continue to scale, it has been possible to perform more complex and computation-intensive tasks in real-time, whereas uniprocessor systems have a significant performance limitation to support these tasks. To fully exploit multicore processors, applications are expected to provide a large degree of parallelism, so that the real-time tasks can utilize multiple cores simultaneously. Only by exploiting parallelism can multicore processors achieve significant real-time performance improvement over traditional single-core processors for computation-intensive real-time applications.

Guaranteeing real-time performance and effectively utilizing available resource capacity requires new scheduling policies that integrate precise schedulability analysis and effect cross-core load balancing. A task is referred to as schedulable if the task can be scheduled to execute while satisfying deadline constraints. The purpose of load balancing on multicore systems is to evenly distribute computational load so that every core can have (ideally) the same amount of work. Most existing research on real-time scheduling for multicore systems has been focused on schedulability. However, these conventional real-time scheduling methods result in a significant loss of performance and resource efficiency since they do not consider parallelism or load balancing during task allocation on multicore systems. In contrast, the prior art methods that do consider load balancing during task allocation often suffer lower schedulability.

What is needed is a real-time scheduling method that not only makes tasks schedulable as much as possible, but also is highly efficient, to utilize resources without waste. Furthermore, what is needed is a method that balances task load across cores in order to improve throughput, reduce energy consumption, and improve reliability.

### SUMMARY OF THE INVENTION

In a first embodiment of the present invention, a method of assigning tasks in a multicore electronic device is provided, the method comprising: receiving a set of tasks; ordering the tasks in non-increasing order of a utilization value of each task; partitioning the ordered tasks using a schedulability-centric algorithm; repartitioning the partitioned ordered tasks by reordering the partitioned ordered tasks in non-decreasing order of the utilization value of each task and partitioning the partitioned reordered tasks using a load-balancing-centric algorithm; and assigning the repartitioned tasks to one or more cores of the multicore electronic device based on results of the repartitioning.

In a second embodiment of the present invention, an apparatus is provided comprising: two or more processors; a local queue corresponding to each of the two or more processors; a partitioning module, comprising: a task scheduler configured to order a plurality of tasks in non-increasing order of a utilization value of each task; a partitioning module configured to partition the ordered tasks using a schedulability-centric algorithm; a repartitioning module configured to repartitioning the partitioned ordered tasks by reordering the partitioned ordered tasks in non-decreasing order of the utilization value of each task and partitioning the partitioned reordered tasks using a load-balancing-centric algorithm; and wherein the partitioning module is configured to assign the repartitioned tasks to the local queues based on results of the repartitioning.

In a third embodiment of the present invention, an apparatus for assigning tasks in a multicore electronic device is provided, the apparatus comprising: means for receiving a set of tasks; means for ordering the tasks in non-increasing order of a utilization value of each task; means for partitioning the ordered tasks using a schedulability-centric algorithm; means for repartitioning the partitioned ordered tasks by reordering the partitioned ordered tasks in non-decreasing order of the utilization value of each task and partitioning the partitioned reordered tasks using a load-balancing-centric algorithm; and means for assigning the repartitioned tasks to one or more cores of the multicore electronic device based on results of the repartitioning.

In a fourth embodiment of the present invention, a non-transitory program storage device readable by a machine tangibly embodying a program of instructions executable by the machine to perform a method of assigning tasks in a multicore electronic device is provided, the method comprising: receiving a set of tasks; ordering the tasks in non-increasing order of a utilization value of each task; partitioning the ordered tasks using a schedulability-centric algorithm; repartitioning the partitioned ordered tasks by reordering the partitioned ordered tasks in non-decreasing order of the utilization value of each task and partitioning the partitioned reordered tasks using a load-balancing-centric algorithm; and assigning the repartitioned tasks to one or more cores of the multicore electronic device based on results of the repartitioning.

### BRIEF DESCRIPTION OF THE DRAWINGS

FIG. 1 is a diagram illustrating a method in accordance with an embodiment of the present invention.

FIG. 2 depicts comparisons between the operations of First Fit Decreasing Utilization (FFDU) and Worst-Fit Decreasing Utilization (WFDU) algorithms alone.

FIG. 3 depicts the operation of the LBTP algorithm of the present invention.

FIG. 4 includes graphs depicting the improvement seen in schedulability when using an LBTP algorithm in accordance with an embodiment of the present invention.

FIG. 5 includes graphs depicting the improvement seen in load-balancing when using an LBTP algorithm in accordance with an embodiment of the present invention.

FIG. 6 includes graphs depicting the improvement seen in energy usage when using an LBTP algorithm in accordance with an embodiment of the present invention.

FIG. 7 is a flow diagram illustrating a method for assigning tasks in a multicore electronic device in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In one embodiment of the present invention, a scheduling method is provided that is designed to support real-time as well as Quality of Service (QoS) requirements on multicore systems. This allows the system to effectively use resources without over-provisioning and wasting potential, even as the number of cores increases. The approach provides good schedulability (i.e., tasks can execute without missing deadlines in higher utilization bounds) and, at the same time, provide increased “use efficiency” through effective load-balancing. Secondary effects include performance improvement and energy reduction.

The basic approach of this embodiment is to first apply a task partitioning mechanism based on schedulability and then, based on this partitioning, re-apply another task partitioning mechanism based on loads balance without disturbing schedulability. The task repartitioning mechanism stops when a task can make no or little improvement in terms of load balancing, which helps reduce the overhead of the solution.

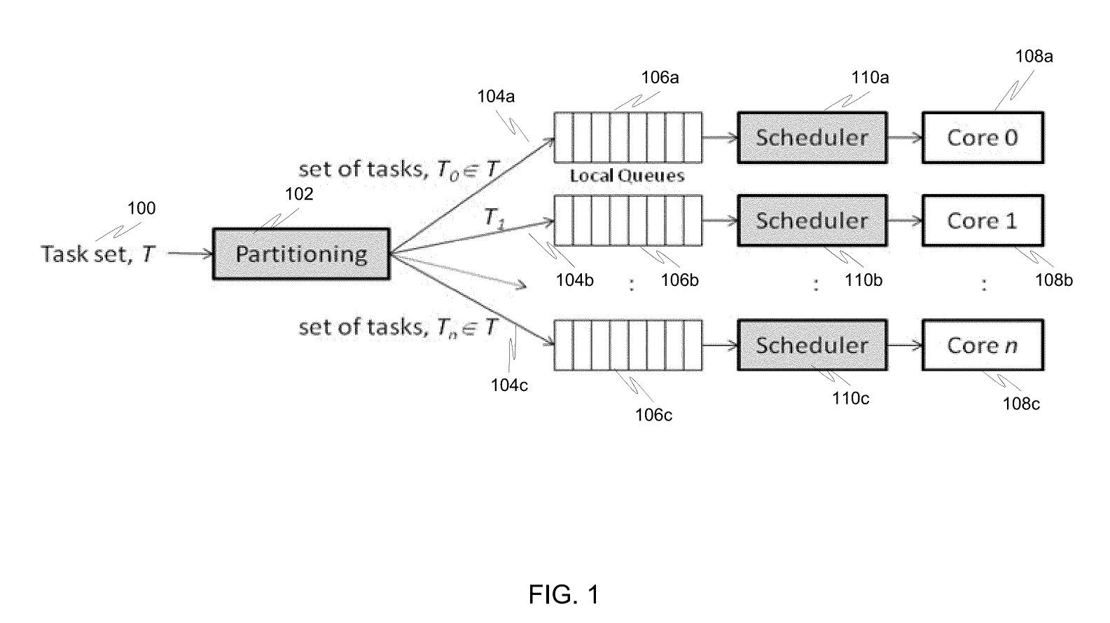

FIG. 1 is a diagram illustrating a method in accordance with an embodiment of the present invention. Here, a task set 100 is passed to a partitioning module 102, which as described later performs not just task partitioning but also task repartitioning. The result of this partitioning and repartitioning is multiple portioned sets of tasks 104a-104c. Each of these sets of tasks is passed to a corresponding local queue 106a-106c, which are designated for corresponding cores 108a-108c. Each core 108a-108c also has its own uniprocessor scheduling method 110a-110c, which schedules the tasks assigned to the corresponding core 108a-108c.

In general, the partitioning/repartitioning takes place prior to system runtime, while the individual cores apply their individual schedulers at runtime.

The partitioning module 102 actually performs three steps: (1) task ordering, (2) task partitioning, and (3) task repartitioning. The overall procedure for this partitioning module may be called “Load Balancing based Task Partitioning” (LBTP).

Task ordering involves sorting the tasks by non-increasing order of utilization values. Non-increasing order means, essentially, decreasing order with the possibilities of ties meaning that subsequently ordered tasks have exactly the same (i.e., non-decreasing and non-increasing) utilization value. The utilization value of each task is represented by execution time divided by period. Therefore, the utilization of task tᵢ, uᵢ, is defined by uᵢ=cᵢ/pᵢ, where cᵢ is the worst execution time of task tᵢ and pᵢ is the period of task tᵢ. These values can be obtained using real-world data or through estimation techniques. The period refers to the time between repeated executions of the task.

Turning to task partitioning, in the sorted order of tasks (i.e., ordered by non-increasing utilization values), each task is assigned to the first core in which it fits. The system can also check if the tasks can be scheduled. It should be noted that in some implementations, task partitioning can be combined with task ordering, such as by using a First Fit Decreasing Utilization (FFDU) algorithm. Such algorithms provide good schedulability.

Task repartitioning is then built upon a schedule generated by the previous proves of task partitioning (as long as the schedule is feasible). In the reverse sorted order of tasks (i.e., ordered by non-decreasing utilization values), each task is assigned to a core with the least utilization value while the task fits on the core. This continues until repartitioning of tasks makes little or no improvement in terms of load balancing. This task repartitioning process incorporates a load balancing test (e.g., standard deviation for the utilization values of cores). The repartitioning process can maintain a feasible solution without re-testing schedulability even though a new solution generated by the repartitioning will be different from the original partitioning. In some implementations, task repartitioning is combined with task ordering, such as by using a Worst Fit

Increasing Utilization (WFIU) algorithm. It is worth noting that the task ordering process does not have to be performed again, since a reverse order from the previously used one can be used.

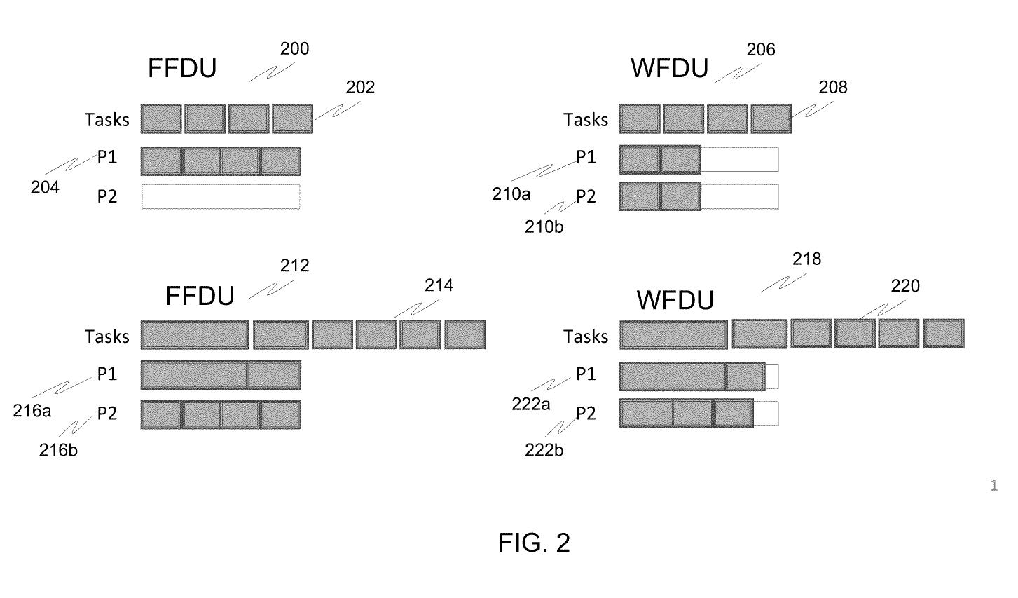

FIG. 2 depicts comparisons between the operations of First Fit Decreasing Utilization (FFDU) and Worst-Fit Decreasing Utilization (WFDU) algorithms alone.

200 shows the organization of tasks after the running of FFDU on tasks 202. As can be seen, all of the tasks have been assigned to a single core 204. In contrast, 206 shows the organization of the same tasks after the running of WFDU on same tasks 208. Here, the tasks are divided evenly between core 210a and core 210b. Thus, for load balancing purposes, WFDU is superior.

However, when using a different set of tasks, one sees the drawbacks of WFDU. Specifically, 212 depicts the organization of tasks after running FFDU on tasks 214. Here, all six tasks 214 have been assigned to the cores 216. Alternatively, 218 depicts using WFDU on same tasks 220, resulting in only five of the six tasks 220 being assigned to cores 222.

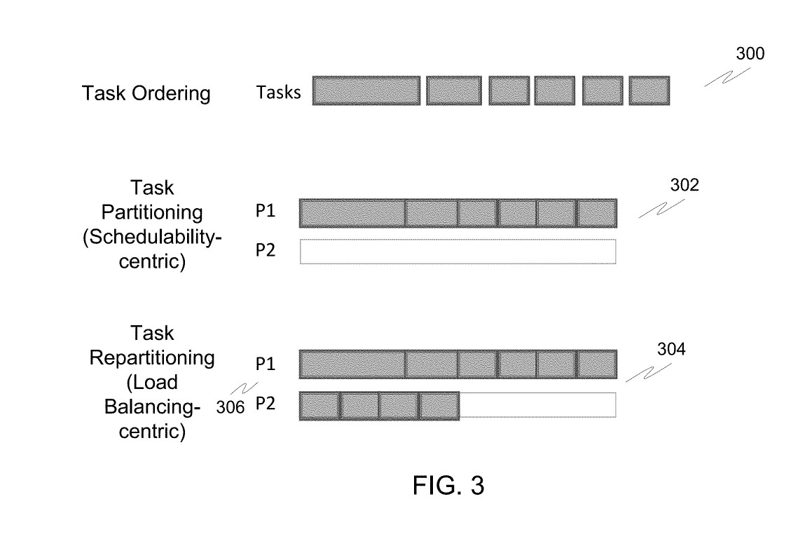

To contrast each of those prior art methods, FIG. 3 depicts the operation of the LBTP algorithm of the present invention. Here, at 300, tasks are first ordered. Then task partitioning takes place using FFDU or some other schedulability-centric algorithm. As can be seen at 302, all tasks have been scheduled, but no load balancing has taken place. At 304, the tasks are repartitioning using WFIU or some other load balancing-centric algorithm, resulting in a distribution of tasks among cores 306 that is based on both schedulability and load-balancing, without ignoring one or the other as the prior art solutions do.

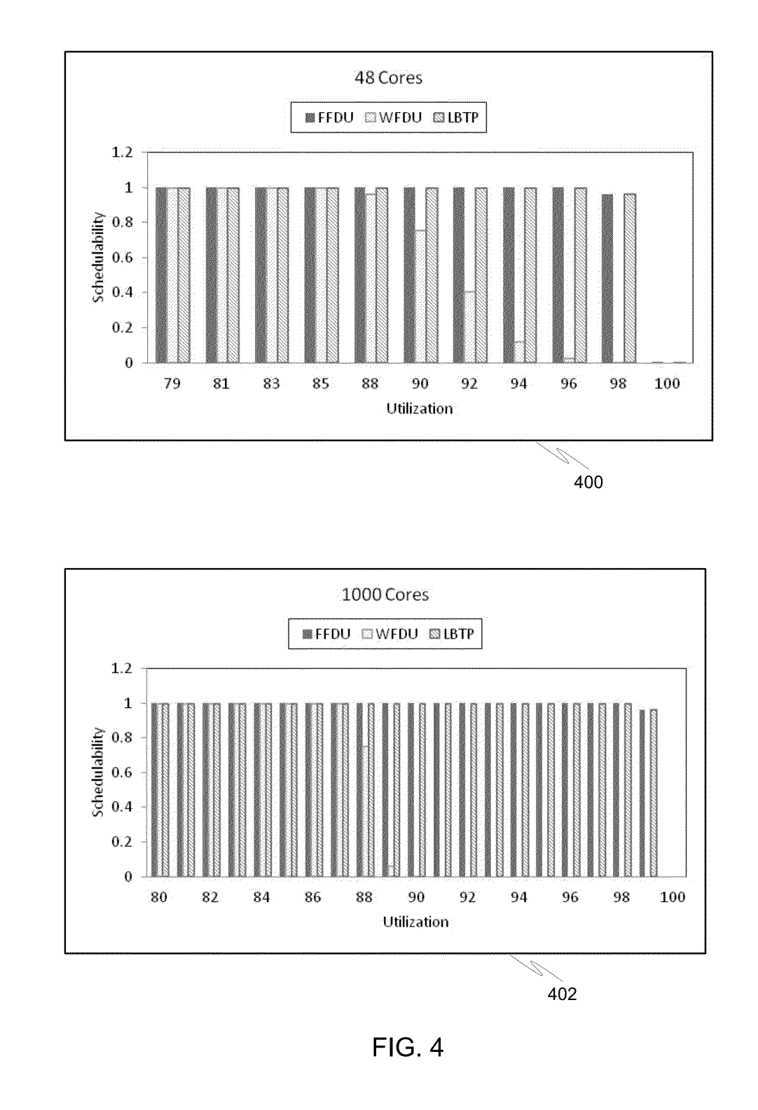

During the course of inventing the present invention, it was unexpectedly discovered that the LBTP algorithm saw significantly improved benefits over all prior art methods. FIG. 4 includes graphs depicting the improvement seen in schedulability when using an LBTP algorithm in accordance with an embodiment of the present invention. Here, 400 depicts a comparison of FFDU, WDFU, and LBTP algorithms for various utilization levels. This comparison is to schedulability. As can be seen, for a 48-core embodiment, LBTP has the same schedulability performance to FFDU, both of which are far superior to WFDU. A similar profile is seen for a 1000-core embodiment at 402. Thus, for schedulability, LBTP is as good as FFDU and far superior to WFDU.

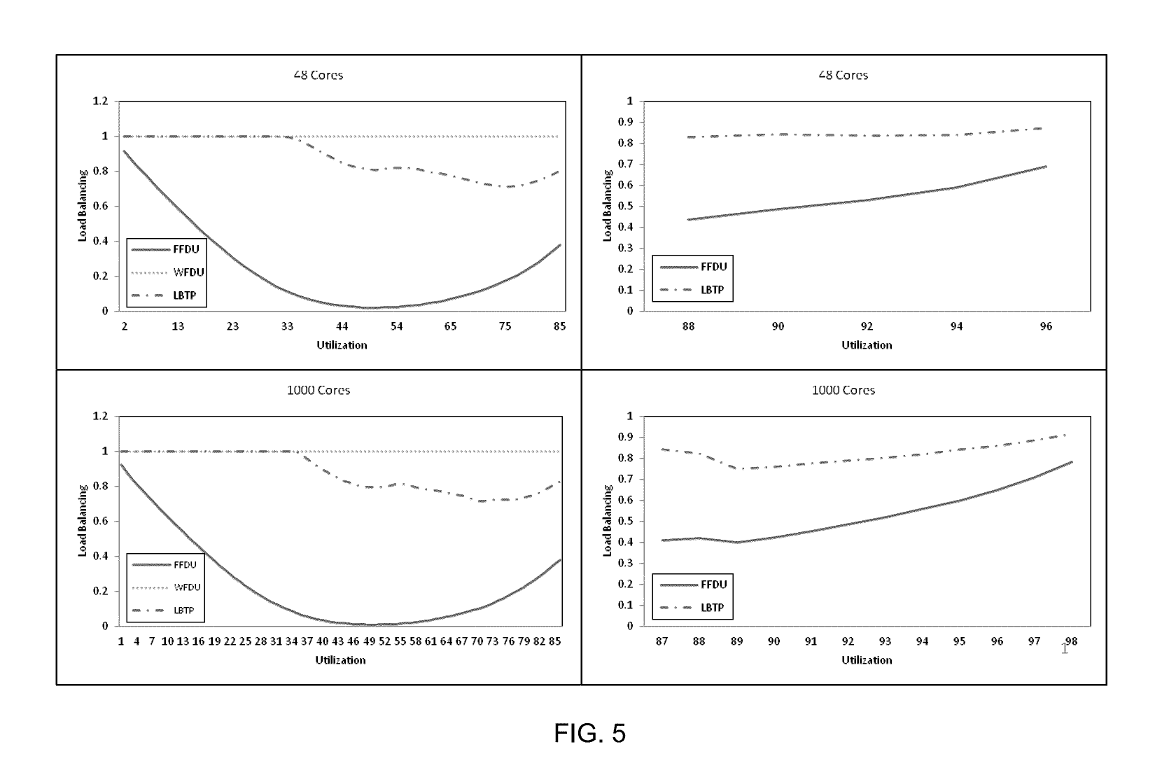

FIG. 5 includes graphs depicting the improvement seen in load-balancing when using an LBTP algorithm in accordance with an embodiment of the present invention. Here, FIG. 5 depicts a comparison of the load-balancing performance of FFDU, WFDU, and LBTP algorithms for various utilizations levels. As can be seen, for a typical 48 core case, depicted in the top left of this figure, WFDU performs the best as far as load balancing, followed closely by LBTP. FFDU, however, is far behind either WFDU or LBTP as far as load balancing performance. Similar results are seen in the 1000 core typical case (bottom left).

The graphs on the right side of this figure represent cases where the WFDU algorithm is actually not able to even schedule the task, and as such load balancing performance of WFDU is irrelevant. In such difficult to schedule cases, LBTP actually outperforms FFDU in both the 48 core and 1000 core embodiments.

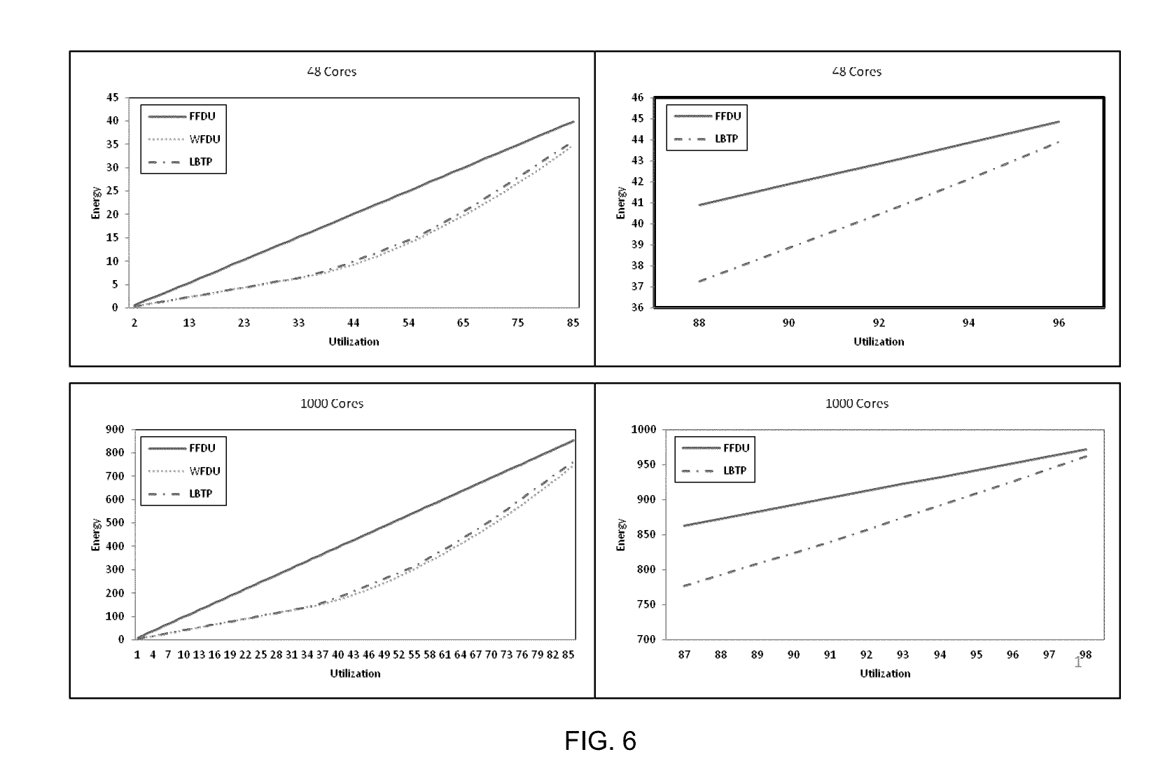

FIG. 6 includes graphs depicting the improvement seen in energy usage when using an LBTP algorithm in accordance with an embodiment of the present invention. These graphs depict roughly the same embodiments as FIG. 5. In the 48 core typical case (top left), WFDU has slightly lower energy usage than LBTP, but both are significantly below FFDU. Similar results are seen in the 1000 core typical case. Once again, the right side depicts cases where WFDU was unable to schedule the tasks and thus energy usage is irrelevant. In those difficult to schedule cases, LBTP actually outperforms FFDU as far as reducing energy usage.

To summarize, based on the experimental results, an embodiment of the present invention (i.e., LBTP) can execute real-time tasks whose total utilization is up to 98% without missing their deadlines. In other words, our invention improves performance by 9-12% compared to WFDU while it provides the same performance with FFDU in terms of schedulability. In terms of load balancing, the performance of our invention is up to 10 times better than one of FFDU which provides good schedulability. Furthermore, this embodiment of the present invention potentially reduces more energy up to 65% than FFDU and provides energy performance compatible to WFDU which provides good energy minimization.

What follows is an example pseudo-code for implementing an embodiment of the present invention. It should be noted that this is merely an example, and is not intended to be limiting on the scope of protection. The pseudo code of LBTP (Load Balancing based Task Partitioning), including task ordering, task partitioning, and then task repartitioning methods, is shown below.

[Pseudo code for LBTP]

FUNCTION LBTP(T, P)

/* task ordering */
Sort tasks in a task list T by non-increasing order of utilization
values of tasks
/* task partitioning */
for each task, tᵢ, i <− 1 to n, tᵢ∈T do

for each processor, pⱼ, pⱼ∈P do

if task tᵢ is schedulable on processor pⱼ then

Assign the task tᵢ to the processor pⱼ
Next i

end if

end for
if the task tᵢ is not assigned to any processor then

return partitioning_failed

end if

end for
/* task repartitioning */
for each task, tᵢ, i <− n to 1, tᵢ∈T do

Find a processor pⱼ (pⱼ∈P) with the least utilization value
Perform a load balancing test
if task, tᵢ improves load balancing on processor pⱼ then

Remove the task tᵢ from its previously assigned
processor
Re-assign the task tᵢ to the processor pⱼ

end if

end for
return task to processor assignment

end FUNCTION

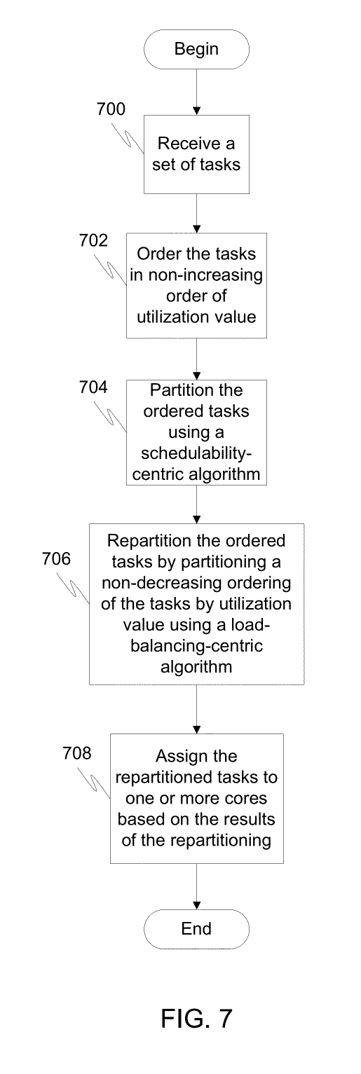

FIG. 7 is a flow diagram illustrating a method for assigning tasks in a multicore electronic device in accordance with an embodiment of the present invention. At 700, a set of tasks is received. At 702, the tasks are ordered in non-increasing order of a utilization value of each task. At 704, the ordered tasks are partitioned using a schedulability-centric algorithm. At 706, the partitioned ordered tasks are repartitioned by reordering the partitioned ordered tasks in non-decreasing order of the utilization value of each task and partitioning the partitioned reordered tasks using a load-balancing-centric algorithm. The “reordering” described here may not require any active steps, as the tasks have already been ordered in non-increasing order at 102, and thus this step could simply use the reverse of that prior ordering. At 708, the repartitioned tasks are assigned to one or more cores of the multicore electronic device based on results of the repartitioning.

It should be noted that to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method of assigning tasks in a multicore electronic device, the method comprising:
receiving a set of tasks;
ordering the tasks in non-increasing order of a utilization value of each task;
partitioning the ordered tasks using a schedulability-centric algorithm;
repartitioning the partitioned ordered tasks by reordering the partitioned ordered tasks in non-decreasing order of the utilization value of each task and partitioning the partitioned reordered tasks using a load-balancing-centric algorithm; and
assigning the repartitioned tasks to one or more cores of the multicore electronic device based on results of the repartitioning.

2. The method of claim 1, wherein a utilization value of a task is its worst execution time divided by its period.

3. The method of claim 1, wherein the schedulability-centric algorithm is a First Fit (FF) algorithm.

4. The method of claim 1, wherein the load-balancing-centric algorithm is a Worst-Fit (WF) algorithm.

5. The method of claim 1, further comprising:
at each of the one or more cores assigned a repartitioned task, after the assignment of the repartitioned tasks, performing a uniprocessor scheduling algorithm on tasks assigned to the corresponding core.

6. The method of claim 1, wherein the reordering is performed by using a reverse order of the ordered tasks resulting from the ordering.

7. An apparatus comprising:
two or more processors;
a local queue corresponding to each of the two or more processors;
a partitioning module, comprising:
a task scheduler configured to order a plurality of tasks in non-increasing order of a utilization value of each task;
a partitioning module configured to partition the ordered tasks using a schedulability-centric algorithm;
a repartitioning module configured to repartitioning the partitioned ordered tasks by reordering the partitioned ordered tasks in non-decreasing order of the utilization value of each task and partitioning the partitioned reordered tasks using a load-balancing-centric algorithm; and
wherein the partitioning module is configured to assign the repartitioned tasks to the local queues based on results of the repartitioning.

8. The apparatus of claim 7, further comprising a uniprocessor scheduling module corresponding to each of the two or more processors.

9. The apparatus of claim 8, wherein the uniprocessor scheduling module is configured to schedule tasks assigned to a corresponding local queue.

10. The apparatus of claim 7, wherein the tasks are tasks that need to be assigned in near-real-time.

11. An apparatus for assigning tasks in a multicore electronic device, the apparatus comprising:
means for receiving a set of tasks;
means for ordering the tasks in non-increasing order of a utilization value of each task;
means for partitioning the ordered tasks using a schedulability-centric algorithm;
means for repartitioning the partitioned ordered tasks by reordering the partitioned ordered tasks in non-decreasing order of the utilization value of each task and partitioning the partitioned reordered tasks using a load-balancing-centric algorithm; and
means for assigning the repartitioned tasks to one or more cores of the multicore electronic device based on results of the repartitioning.

12. The apparatus of claim 11, wherein a utilization value of a task is its worst execution time divided by its period.

13. The apparatus of claim 11, wherein the schedulability-centric algorithm is a First Fit (FF) algorithm.

14. The apparatus of claim 11, wherein the load-balancing-centric algorithm is a Worst-Fit (WF) algorithm.

15. The apparatus of claim 11, further comprising:
means for, at each of the one or more cores assigned a repartitioned task, after the assignment of the repartitioned tasks, performing a uniprocessor scheduling algorithm on tasks assigned to the corresponding core.

16. The apparatus of claim 11, wherein the means for reordering is performed by means for using a reverse order of the ordered tasks resulting from the ordering.

17. A non-transitory program storage device readable by a machine tangibly embodying a program of instructions executable by the machine to perform a method of assigning tasks in a multicore electronic device, the method comprising:
receiving a set of tasks;
ordering the tasks in non-increasing order of a utilization value of each task;
partitioning the ordered tasks using a schedulability-centric algorithm;
repartitioning the partitioned ordered tasks by reordering the partitioned ordered tasks in non-decreasing order of the utilization value of each task and partitioning the partitioned reordered tasks using a load-balancing-centric algorithm; and
assigning the repartitioned tasks to one or more cores of the multicore electronic device based on results of the repartitioning.

18. The non-transitory program storage device of claim 17, wherein the schedulability-centric algorithm is a First Fit (FF) algorithm.

19. The non-transitory program storage device of claim 17, wherein the load-balancing-centric algorithm is a Worst-Fit (WF) algorithm.

20. The non-transitory program storage device of claim 17, further comprising:
at each of the one or more cores assigned a repartitioned task, after the assignment of the repartitioned tasks, performing a uniprocessor scheduling algorithm on tasks assigned to the corresponding core.
